(19) United States
(12) Patent Application Publication
(10) Pub. No.: US 2020/0192554 A1
(43) Pub. Date: Jun. 18, 2020

(54) TERMINAL DEVICE, DISPLAY CONTROL METHOD IMPLEMENTED BY THE TERMINAL DEVICE, COMPUTER READABLE STORAGE MEDIUM AND COMPUTER PROGRAM PRODUCT

(71) Applicants: BOE Technology Group Co., Ltd., Beijing (CN); Chengdu BOE Optoelectronics Technology Co., Ltd., Chengdu (CN)

(72) Inventors: Shuai Ye, Beijing (CN); Yong Yu, Beijing (CN); Xiaohuan Chang, Beijing (CN); Chuanyan Lan, Beijing (CN); Lianbin Liu, Beijing (CN)

(21) Appl. No.: 16/304,909

(22) PCT Filed: Feb. 6, 2018
(86) PCT No.: PCT/CN2018/075419

§ 371 Date: Nov. 27, 2018

(30) Foreign Application Priority Data
Jul. 4, 2017 (CN) 201710541076.9

(51) Int. Cl. G06F 3/0484; G06F 3/0482; G06F 3/14

(52) U.S. Cl. CPC G06F 3/04845; G06F 2203/04803; G06F 3/1407; G06F 3/0482

(57) ABSTRACT

Embodiments of the present disclosure provide a terminal device, a display control method implemented by the terminal device, a computer readable storage medium, and a computer program product. The display control method includes: displaying, during a first time period of a display period, a first display sub-interface in a first display area of a display unit of the terminal device using a first color combination scheme; and displaying, during a second time period of the display period, the first display sub-interface in the first display area using a second color combination scheme different from the first color combination scheme.

### CROSS-REFERENCE TO RELATED APPLICATION(S)

This application claims priority to the Chinese Patent Application No. 201710541076.9, filed on Jul. 4, 2017, which is incorporated herein by reference in its entirety.

### TECHNICAL FIELD

The present disclosure relates to the field of display technology, and more particularly, to a terminal device, a display control method implemented by the terminal device, a computer readable storage medium and a computer program product.

### BACKGROUND

Mobile phones utilizing Organic Light-emitting Diode (OLED) or Active Matrix Organic Light-Emitting Diode (AMOLED) display technology are becoming more and more popular. However, aging of organic light-emitting material of an OLED is accelerated when the OLED is in an always-on state, which may easily lead to the afterimage phenomenon, thereby resulting in poor user experience. For example, a status bar in a display interface of a mobile phone always displays almost the same status (for example, information related to an operator, power of the mobile phone, signal strength, etc.) when a screen of the mobile phone is in a turn-on state. Thereby, for a mobile phone utilizing the OLED display technology, poor display may easily occur in a display area of a status bar of the mobile phone.

### SUMMARY

According to an aspect of the embodiments of the present disclosure, there is provided a display control method implemented by a terminal device, comprising: displaying, during a first time period of a display period, a first display sub-interface in a first display area of a display unit of the terminal device using a first color combination scheme; and displaying, during a second time period of the display period, the first display sub-interface in the first display area using a second color combination scheme different from the first color combination scheme.

In an embodiment, the display control method further comprises: displaying, during the first time period and the second time period, a second display sub-interface in a second display area of the display unit using a same color combination scheme.

In an embodiment, the first color combination scheme and the second color combination scheme specify different colors for a background, and the first color combination scheme and the second color combination scheme specify different colors for display information.

In an embodiment, the display period is composed of the first time period and the second time period.

In an embodiment, the first time period has a same duration as the second time period.

In an embodiment, a duration of the first time period and a duration of the second time period both range from 10 s to 30 s.

According to another aspect of the embodiments of the present disclosure, there is further provided a terminal device, comprising: a display unit, configured to display a display interface comprising a first display sub-interface and a second display sub-interface; a control unit configured to control the display unit to perform the following operations: displaying, during a first time period of a display period, the first display sub-interface in a first display area using a first color combination scheme; and displaying, during a second time period of the display period, the first display sub-interface in the first display area using a second color combination scheme different from the first color combination scheme.

In an embodiment, the control unit is further configured to control the display unit to perform the following operation: displaying, during the first time period and the second time period, a second display sub-interface in a second display area using a same color combination scheme.

In an embodiment, the first color combination scheme and the second color combination scheme specify different colors for a background, and the first color combination scheme and the second color combination scheme specify different colors for display information.

In an embodiment, the display period is composed of the first time period and the second time period.

In an embodiment, the first time period has a same duration as the second time period.

In an embodiment, a duration of the first time period and a duration of the second time period both range from 10 s to 30 s.

According to yet another aspect of the embodiments of the present disclosure, there is further provided a computer readable storage medium having instructions stored thereon, which, when executed by a terminal device, cause the terminal device to perform the display control method described above.

According to a further aspect of the embodiments of the present disclosure, there is further provided a computer program product comprising instructions, which, when executed by a terminal device, cause the terminal device to perform the display control method described above.

### BRIEF DESCRIPTION OF THE DRAWINGS

In order to more clearly illustrate the technical solutions in the embodiments of the present disclosure or in the conventional techniques, the accompanying drawings required to be used in the description of the embodiments or the conventional techniques will be briefly described below. It is obvious that the accompanying drawings in the following description are only some of the embodiments of the present disclosure, and other accompanying drawings may also be obtained by those of ordinary skill in the art according to these accompanying drawings without any creative work.

FIG. 1 is a schematic flowchart of a display control method implemented by a terminal device according to an embodiment of the present disclosure;

FIG. 2a illustrates a schematic diagram of a user interface of a terminal device comprising display sub-interfaces according to an embodiment of the present disclosure;

FIG. 2b illustrates a schematic diagram of another user interface of a terminal device comprising display sub-interfaces according to an embodiment of the present disclosure;

FIG. 3 illustrates a schematic diagram of yet another user interface of a terminal device comprising display sub-interfaces according to an embodiment of the present disclosure;

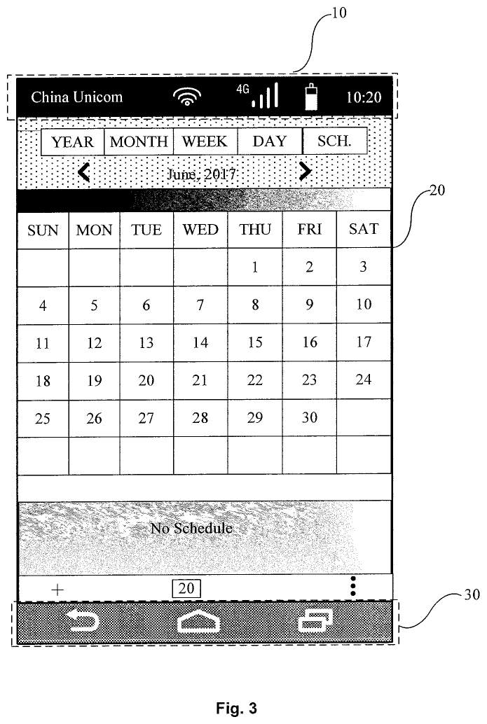

FIG. 4 illustrates a schematic diagram of a further user interface of a terminal device comprising display sub-interfaces according to an embodiment of the present disclosure;

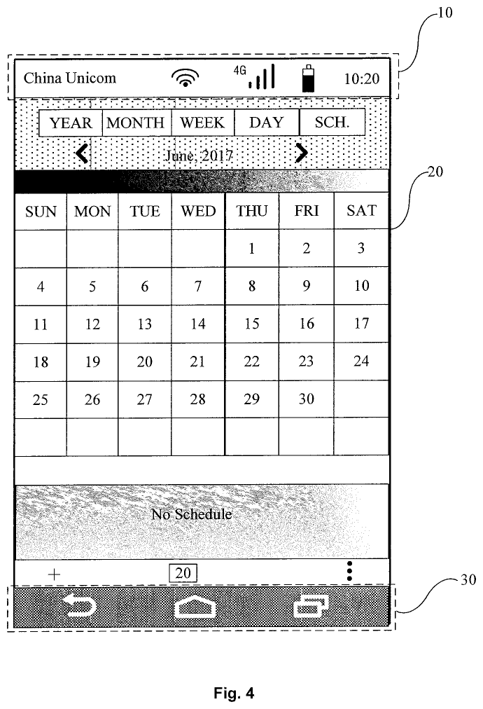

FIG. 5 illustrates a flowchart of another display control method implemented by a terminal device according to an embodiment of the present disclosure; and

FIG. 6 illustrates a schematic diagram of a terminal device according to an embodiment of the present disclosure.

### DETAILED DESCRIPTION

The technical solutions in the embodiments of the present disclosure will be clearly and completely described below in conjunction with the accompanying drawings in the embodiments of the present disclosure. It is obvious that the embodiments described are only a part of the embodiments of the present disclosure, and not all of the embodiments. All other embodiments obtained by those of ordinary skill in the art based on the embodiments of the present disclosure without any creative work fall within the protection scope of the present disclosure.

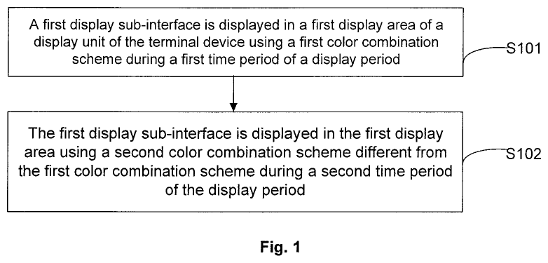

The embodiments of the present disclosure provide a display control method implemented by a terminal device. As shown in FIG. 1, the display control method comprises the following steps.

In step S101, a first display sub-interface is displayed in a first display area of a display unit of the terminal device using a first color combination scheme during a first time period of a display period.

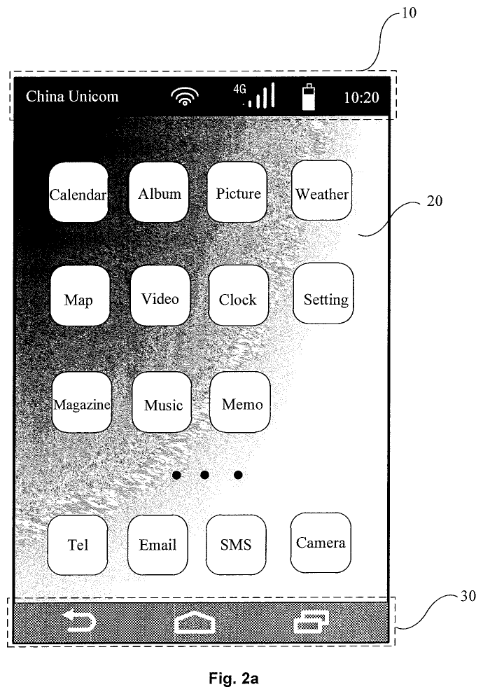

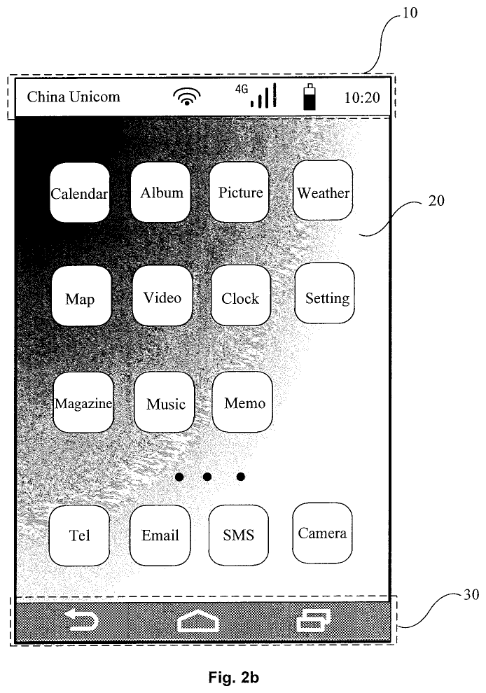

The present disclosure will be described by taking the terminal device being a mobile phone as an example (of course, the present disclosure is not limited thereto, and the terminal device may also be other terminal devices such as a tablet computer etc.) As shown in FIG. 2a, a User Interface (UI) is displayed on the display unit (i.e., a display screen) of the mobile phone. The user interface is generally divided into a plurality of display areas, and various display areas are used to display different display sub-interfaces. For example, the user interface may generally comprise a status bar display area 10, an application display area 20, and a navigation bar display area 30, which are configured to display a status bar sub-interface, an application sub-interface, and a navigation bar sub-interface, respectively. Here, the status bar display area 10 and the navigation bar display area 30 are generally displayed in a relatively fixed manner using a layout structure comprising a specific background and function or status information, and in contrast, depending on applications used, the application display area 20 may present a layout, background and content which are completely different from those of the status bar display area 10 and the navigation bar display area 30. In the present disclosure, the first display area may be the status bar display area 10 and/or the navigation bar display area 30, and the present disclosure is, of course, not limited thereto. The following embodiments are described by taking the first display area being the status bar display area 10 as an example.

Specifically, for the status bar display area 10, the status information is information to be displayed in the status bar display area, and may comprise: icons, characters, etc., wherein the characters may comprise letters, numbers, etc.

Specifically, in the above step S101, during the first time period of the display period, the status bar sub-interface is displayed in the status bar display area 10 using the first color combination scheme. In one embodiment, the display may be performed using a color combination scheme which specifies a black background and white display information as shown in FIG. 2a to provide a user with required status information (operator, power of the mobile phone, signal strength, etc.)

In step S102, the first display sub-interface is displayed in the first display area using a second color combination scheme different from the first color combination scheme during a second time period of the display period.

By still taking the above example for description, during the second time period of the display period, the status bar sub-interface is displayed in the status bar display area 10 using the second color combination scheme. In one embodiment, the display may be performed using a color combination scheme which specifies a white background and black display information as shown in FIG. 2b.

In one embodiment, the display period is composed of the first time period and the second time period. That is, after the second time period has elapsed, the process proceeds to a first time period of a next display period, the method may return to step S101 to perform display using the first color combination scheme again, and this process may continue in this way.

In another embodiment, the display period may further comprise one or more other time periods. In all of the time periods, the same or different color combination schemes may be specified to display the status bar sub-interface in the status bar display area 10.

In still another embodiment, the first time period and the second time period may not be continuous, for example, there may be an intermediate time period between the first time period and the second time period. The display control method may comprise: displaying the status bar sub-interface in the status bar display area 10 using a scheme having an index (for example, chroma, grayscale, etc.) between that of the first color combination scheme and that of the second color combination scheme. For example, if a gray color scheme is used, display is performed using a color combination scheme which specifies a gray background and gray display information. Alternatively, in another embodiment, the display control method may comprise: displaying the status bar sub-interface in the status bar display area 10 using a color combination scheme having a gradual change in an index (for example, chroma, grayscale, etc.) from the first color combination scheme to the second color combination scheme during the intermediate time period.

It should be illustrated here that, firstly, the first color combination scheme which specifies the black background and white display information shown in FIG. 2a and the second color combination scheme which specifies the white background and black display information shown in FIG. 2b are only given as an example. Actual color combinations of the background and the display information in the first color combination scheme and the second color combination scheme are not limited in the present disclosure. For example, the background may be a pattern having multiple colors (gradually changing colors, etc.), and the display information has a pure color (a single color, e.g. yellow, green, etc.); or the background and the display information both have pure colors (a combination of red and green, or a combination of yellow and blue etc.) In practice, a required color combination scheme may be set according to requirements; and of course, the color combination may also be combined with brightness, for example, the background is dark red, and the display information is light red.

Secondly, two color combination schemes are different color combination schemes as long as one of the background and the display information of the display sub-interface is of different color for these two color combination schemes. For example, a color combination scheme which specifies a black background and white display information and a color combination scheme which specifies a black background and yellow display information are two different color combination schemes. In an embodiment of the present disclosure, the color of the background in the first color combination scheme is different from the color of the background in the second color combination scheme, and the color of the display information in the first color combination scheme is different from the color of the display information in the second color combination scheme. Thereby, the entire first display area (the background and the display information) is switched, which can effectively avoid display disadvantages caused by the display sub-interface being in the same state for a long time.

Of course, in order to ensure that a display picture in the first display area has a good display effect, for example, the picture is clear, and in order to visually reduce the interference of a color display picture in the first display area to a display picture in the application display area 20 (a main display area of the terminal device) as much as possible, in an embodiment of the present disclosure, the colors of the background and the display information in the color combination schemes are black and white. For example, for the status bar display area 10 shown in FIGS. 2a and 2b, the first color combination scheme may specify a black background and white display information for the first status bar, and the second color combination scheme may specify a white background and black display information for the first status bar.

Thirdly, parameters (parameters for determining the color combination scheme) for setting the display sub-interface may be preset in the terminal device or may be acquired through a network, for example, the terminal device may periodically acquire the parameters for setting the display sub-interface from a display sub-interface database (which is provided in a server of the network) connected to the terminal device.

In summary, compared with the conventional techniques in which the status bar display area is in the same state (i.e., using the same color combination scheme) for a long time, in the present disclosure, the same display sub-interface (for example, the status bar sub-interface) is displayed using different color combination schemes during different time periods of the display period, which avoids the display disadvantages, such as the afterimage phenomenon, caused by the display sub-interface being in the same state for a long time in the conventional techniques.

It should be illustrated here that, for the display disadvantages caused by a specific display area (especially the status bar display area) being in the same state for a long time, as described above, for the terminal device using the OLED display, since aging of the organic light-emitting material is more rapid in an always-on state than in an intermittent-on state, it may easily cause the afterimage phenomenon in the display area of the display apparatus. However, the display control method according to the present disclosure is not limited to be applied to the terminal device using the OLED display, and may also be applied to a terminal device using LCD display, and can also avoid other display disadvantages caused by the terminal device using the LCD display being in the same state for a long time.

In the above method, the first time period may be different from or the same as the second time period. Preferably, the first time period may be set to have the same duration as that of the second time period, wherein the duration is in a range from 10 s to 30 s.

With respect to the range of the duration, if the duration of the first time period and the second time period is set to be less than 10 s, it may result in a large switching frequency of the display picture, thereby causing a visual fatigue effect on the user. If the duration of the first time period and the second time period is set to be greater than 30 s, the adverse effect on the display picture caused by the display sub-interface being in the same state for a long time cannot be effectively reduced.

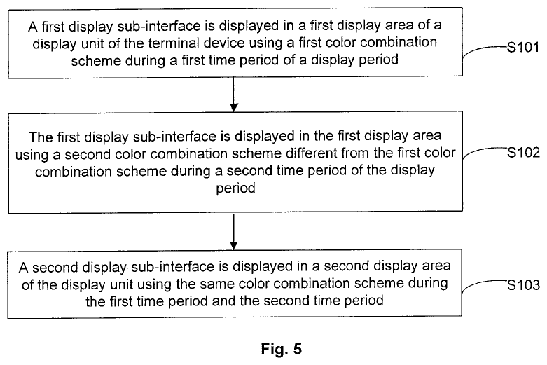

In the following embodiments, the display control method according to the present disclosure is further described in conjunction with display control of a second display area different from the first display area. As shown in FIG. 5, the display control method further comprises the following steps.

In step S103, a second display sub-interface is displayed in a second display area of the display unit using the same color combination scheme during the first time period and the second time period.

Unlike a case where the color combination scheme is changed for the entire user interface, in the embodiment of the present disclosure, the color combination scheme may be periodically changed only for the first display sub-interface (for example, the status bar sub-interface 10) for specific display, so as to avoid the display disadvantages caused by the display sub-interface being in the same state for a long time. For a sub-interface (for example, the application sub-interface) where display content may change frequently, there are usually no such disadvantages, and therefore, it is not necessary to periodically change the color combination scheme of the sub-interface. In this way, the effect of the color combination scheme on the user experience may be reduced.

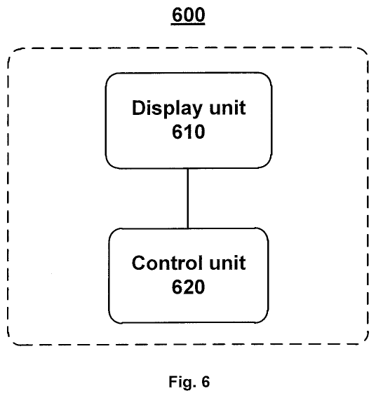

As shown in FIG. 6, the embodiments of the present disclosure further provide a terminal device 600, comprising a display unit and a 610 and a control unit 620. The display unit 610 is configured to display a display interface comprising a first display sub-interface and a second display sub-interface. The control unit 620 is configured to control the display unit 610 to perform the following operations: displaying, during a first time period of a display period, the first display sub-interface in a first display area using a first color combination scheme; and displaying, during a second time period of the display period, the first display sub-interface in the first display area using a second color combination scheme different from the first color combination scheme.

In one embodiment, the control unit 620 is further configured to control the display unit 610 to perform the following operations: displaying, during the first time period and the second time period, a second display sub-interface in a second display area using the same color combination scheme.

In one embodiment, the first color combination scheme and the second color combination scheme specify different colors for a background, and the first color combination scheme and the second color combination scheme specify different colors for display information.

In one embodiment, the display period is composed of the first time period and the second time period.

In one embodiment, the first time period has a same duration as the second time period.

In one embodiment, a duration of the first time period and a duration of the second time period both range from 1 s to 30 s.

It should be illustrated that, firstly, the terminal device 600 performs display by using the display control method corresponding to the above embodiments, and has the same beneficial effects as those of the above display control method. Since the beneficial effects of the display control method have already been described in detail in the above embodiments, the beneficial effects of the terminal device 600 will not be described in detail here.

Secondly, each module in the present embodiment may be a processor which is separately provided, or may be integrated in a certain processor of an apparatus for generating an image, or may be stored in a memory of the apparatus for generating an image in a form of program codes to be invoked by a certain processor of the apparatus for generating an image and implement functions of various units described above. The processor described here may be a Central Processing Unit (CPU for short), a Graphics Processing Unit (GPU for short) or an Application Specific Integrated Circuit (ASIC for short), or one or more integrated circuits configured to implement the embodiments of the present disclosure, which is not limited in the present disclosure.

The embodiments of the present disclosure further provide a computer readable storage medium having instructions stored thereon, which, when executed by a terminal device, cause the terminal device to perform the display control method described above. Since the beneficial effects of the display control method have already been described in detail in the above embodiments, the beneficial effects of the computer readable storage medium will not be described in detail here.

The embodiments of the present disclosure further provide a computer program product comprising instructions, which, when executed by a terminal device, cause the terminal device to perform the display control method described above. Since the beneficial effects of the display control method have already been described in detail in the above embodiments, the beneficial effects of the computer program product will not be described in detail here.

It can be understood by those of ordinary skill in the art that all or a part of the steps for implementing the above method embodiments may be completed by a program instructing related hardware, and the program may be stored in a computer readable storage medium, and when the program is executed, the steps of the above method embodiments are performed. The storage medium comprises: a medium which may store program codes, such as a Read Only Memory (ROM), a Random Access Memory (RAM), a magnetic disk, or an optical disk etc.

The above description is only the specific embodiments of the present disclosure, but the protection scope of the present disclosure is not limited thereto. Changes or substitutions which are easily reached by those skilled in the art within the technical scope of the present disclosure should be covered within the protection scope of the present disclosure. Therefore, the protection scope of the present disclosure should be determined by the protection scope of the claims.

1. A display control method implemented by a terminal device, comprising:
displaying, during a first time period of a display period, a first display sub-interface in a first display area of a display unit of the terminal device using a first color combination scheme; and
displaying, during a second time period of the display period, the first display sub-interface in the first display area using a second color combination scheme different from the first color combination scheme.

2. The display control method according to claim 1, further comprising:
displaying, during the first time period and the second time period, a second display sub-interface in a second display area of the display unit using a same color combination scheme.

3. The display control method according to claim 1, wherein the first color combination scheme and the second color combination scheme specify different colors for a background, and the first color combination scheme and the second color combination scheme specify different colors for display information.

4. The display control method according to claim 1, wherein the display period is composed of the first time period and the second time period.

5. The display control method according to claim 1, wherein the first time period has a same duration as the second time period.

6. The display control method according to claim 1, wherein a duration of the first time period and a duration of the second time period both range from 10 s to 30 s.

7. A terminal device, comprising:
a display unit, configured to display a display interface comprising a first display sub-interface and a second display sub-interface;
a control unit configured to control the display unit to perform the following operations:
displaying, during a first time period of a display period, the first display sub-interface in a first display area using a first color combination scheme; and
displaying, during a second time period of the display period, the first display sub-interface in the first display area using a second color combination scheme different from the first color combination scheme.

8. The terminal device according to claim 7, wherein the control unit is further configured to control the display unit to perform the following operation:
displaying, during the first time period and the second time period, a second display sub-interface in a second display area using a same color combination scheme.

9. The terminal device according to claim 7, wherein the first color combination scheme and the second color combination scheme specify different colors for a background, and the first color combination scheme and the second color combination scheme specify different colors for display information.

10. The terminal device according to claim 7, wherein the display period is composed of the first time period and the second time period.

11. The terminal device according to claim 7, wherein the first time period has a same duration as the second time period.

12. The terminal device according to claim 7, wherein a duration of the first time period and a duration of the second time period both range from 10 s to 30 s.

13. A computer readable storage medium having instructions stored thereon, which, when executed by a terminal device, cause the terminal device to perform the display control method according to claim 1.

14. A computer program product comprising instructions, which, when executed by a terminal device, cause the terminal device to perform the display control method according to claim 1.

15. A computer readable storage medium having instructions stored thereon, which, when executed by a terminal device, cause the terminal device to perform the display control method according to claim 2.

16. A computer readable storage medium having instructions stored thereon, which, when executed by a terminal device, cause the terminal device to perform the display control method according to claim 3.

17. A computer readable storage medium having instructions stored thereon, which, when executed by a terminal device, cause the terminal device to perform the display control method according to claim 4.

18. A computer program product comprising instructions, which, when executed by a terminal device, cause the terminal device to perform the display control method according to claim 2.

19. A computer program product comprising instructions, which, when executed by a terminal device, cause the terminal device to perform the display control method according to claim 3.

20. A computer program product comprising instructions, which, when executed by a terminal device, cause the terminal device to perform the display control method according to claim 4.
